(19) United States
(12) Patent Application Publication
(10) Pub. No.: US 2019/0259083 A1
(43) Pub. Date: Aug. 22, 2019

(54) METHOD FOR PARTICIPATING IN FRIEND'S PURCHASE PROCESS BY DIRECTLY PUSHING PRODUCT TO FRIEND'S ACCOUNT PAGE

(71) Applicant: IMAGEDROME, INC., Seoul (KR)

(72) Inventors: Sang Jean HONG, Seoul (KR); Sun Young MOON, Seoul (KR)

(21) Appl. No.: 16/308,633

(22) PCT Filed: Jun. 13, 2017
(86) PCT No.: PCT/KR2017/006109

§ 371 Date: Dec. 10, 2018

(30) Foreign Application Priority Data
Jun. 15, 2016 (KR) 10-2016-0074244

(51) Int. Cl. G06Q 30/06; H04L 12/58

(52) U.S. Cl. CPC G06Q 30/0631; G06Q 30/0643; H04L 51/046; G06Q 30/0625; G06Q 30/0635

(57) ABSTRACT

The present invention relates to an online shopping method, and more particularly, to a method of pushing an item to a friend account at an online shopping site or the like. The method of the present invention includes a first device 100 selecting an item from a shopping site subscribed as a first user account, when designating a second user account registered in advance as a friend relationship, and generating an item transmission event, the shopping site server 300 inserting the item into a list of an item page of the second user account. A second device 200 of the second user account logs in to the shopping site to check the item registered on its item page.

### TECHNICAL FIELD

The present invention relates to on-line or mobile commerce, and more particularly, to a product recommendation method.

### BACKGROUND ART

Shopping is life. With advances in device and platform technology, users may shop anytime, anywhere. Users may access the shopping mall site through the Internet web browser or purchase the product through the mobile app. Because shopping becomes easy, competition becomes fierce. Operators of shopping platforms have provided technology solutions that make shopping easier and more convenient. In the meantime, the operators have launched a policy to actively attract buyers rather than waiting for buyers to shop.

Such a technique is that a software machine collects and analyzes big data and recommends a product. However, the user is treated as an element of big data and is remained theoretically and indirectly until it leads to actual purchase. If the purchase is triggered by someone without the consumer's individual taste and determination, it is due to a friend's recommendation. As a user become more intimate with your friends or trust them more, a friend's recommendation has a direct impact on the purchase.

In an internet communication environment, how a friend recommendation is made? First, there is a method of transmitting an image. If the user who receives the image wants to purchase it, the user must search online, finds the seller, and then makes purchases, including logins. It is troublesome. A friend may recommend the purchase through a second method. It is a method of transmitting the link connected to a site of the recommended product and the seller. The user who receives the link may access the seller's site by clicking the link. It is easier than the first method, but a user has to go through the process of signing in and choosing a product for purchase.

Not all users who receive a product recommendation have high purchase intentions. Although users receive the link, not all users click on the link. Even if accessing the seller's site according to the link, he/she does not log in and then, select and purchase the recommended product. There are many steps to be taken, and the users tend to leave each step.

If a friend makes a recommendation some product; and if a user has an optimal opportunity to make a purchase it, should the method to buy be most convenient and easiest? The inventors repeatedly asked whether the question was right; and have long struggled to find an appropriate solution. Finally, it has come to complete the present invention by finding the most simple and perfect solution after investigating and studying for many years.

### DISCLOSURE OF THE INVENTION

### Technical Problem

It is an object of the present invention to provide a method for automatically creating a state that order is made quickly and easily in a case of a product recommended by a friend; it can be called ‘one-click order’.

In the present invention, both ‘I’ and ‘My Friend’ exist as user accounts. Therefore, the expression ‘Friend’ in this specification means a user account defined as a friend on the network and registered in the system.

Another object of the present invention is to promote the spread of shopping by providing the technical environment to allow the product recommendation between friends to easily reach the payment.

Moreover, other objects of the present invention which are not explicitly stated will be further considered within the scope easily deduced from the following detailed description and the effects thereof.

### Technical Solution

Embodiments of the present invention provide a method of pushing an item to a friend account, the method comprising:

a first device selecting an item from a shopping site subscribed as a first user account;

designating a second user account registered in advance as a friend relationship, and generating an item transmission event;

the shopping site server inserting the item into a list of an item page of the second user account; and

a second device of the second user account logging in to the shopping site to check the item registered on the item page.

In an embodiment, the shopping site server provides the first device with second user account information of the second device through a first user account screen of the first device, and further provides the second device with the first device user account information recommending an item through the item page of the second user account of the second device.

In another embodiment of the present invention, an online shopping method comprising:

a first device and a second device subscribing to a shopping site;

the first device and the second device registering a friend relationship on the shopping site;

the first device selecting an item at the shopping site to generate an item transmission event to the second device;

the shopping site server inserting the item into a list of an item page of a second device account; and

the second device logging in to the shopping site checking the item selected by the first device registered in the item page of its account; and buying the item.

In an embodiment, the method may further include, when the item transmission event is generated, the shopping site server notifying that an item is transmitted from the first device to the second device.

In an embodiment, when the second device purchases the item, the shopping site server notifying that the second device purchases the item to the first device.

In an embodiment, the second device is in plurality, further comprising the shopping site server assigning a pre-determined advantage event in correspondence to each time the second device purchases the item.

In other embodiments of the present invention, a method of pushing an item to a friend account, the method comprising:

a first device subscribed to an online site registering a friend relationship with N (N is an integer greater than 1) second devices subscribed to the online site;

the first device selecting an item from the online site, and designating K (K is an integer larger than 1 and N or less) second devices to generate an item transmission event;

the online site server inserting the item into a list of an item page of the K second device accounts; and

logging, by the second device that is a target of the item transmission event of the first device, in to the online site checking the item included in the list of the item page.

In an embodiment, the method may further include the second device executing a purchase event for the item included in the item page,

wherein depending a purchase event, the online site server provides the second device with a pre-determined purchasing process and executes an advantage event on the first device when the purchasing process is completed.

In still other embodiments of the present invention, a mobile shopping method includes:

a first mobile device and a second mobile device installing a mobile shopping application provided by a shopping service server;

the first mobile device and the second mobile device creating a friend relationship to register it on the shopping service;

after the first mobile device executes the mobile shopping application, selecting an item, designating the second mobile device, and generating an item transmission event;

the shopping service server inserting the item into a list of an item page of the account of the second mobile device; and

the second mobile device executing the mobile shopping application to check the item included in a list of the item page and executing a purchase event for this item.

In an embodiment, the second mobile device may be in plurality.

### Advantageous Effects

According to the present invention, since a friend's product recommendation is automatically pushed into a user's account, even if a user who receives the recommendation forgets the product recommendation, just by accessing the server, the user may find recommendations and the products at any time. In addition, it has the advantage of being able to make an immediate payment from a user's account, so that a user may make payments quickly. If product recommendations spread a lot between users because of these effects, friendship creation itself will be more active, and if so, an atmosphere where shopping sites and social networks may converge may be created.

Moreover, according to the present invention, the product may be spread more quickly and widely in the network by product recommendations made by users, and this may also lead to the development of the shopping industry.

On the other hand, even if the effects are not explicitly mentioned here, the effects described in the following specification, which are expected by the technical characteristics of the present invention, and the provisional effects thereof are handled as described in the specification of the present invention.

### BRIEF DESCRIPTION OF THE DRAWINGS

FIG. 1A is a view related to the prior art.

FIG. 1B is a view showing a basic problem in FIG. 1A.

FIG. 1C is a view related to a basic concept of the present invention.

FIG. 1D is a view showing a relative technical effect in FIG. 1C by comparison with FIG. 1A.

FIG. 2 is a view showing an example of the overall system configuration according to a preferred embodiment of the present invention.

FIG. 3 is a view schematically showing a relationship between a server 300, a first device 100, and a second device 200 according to a preferred embodiment of the present invention.

FIG. 4 shows the relationship between the plurality of second devices 200 and the first device 100.

FIG. 5 shows an exemplary screen configuration of an item page 2500 included in the user account page 2000 of the second device 200 according to a preferred embodiment of the present invention.

FIG. 6 is a schematic view of the overall process of a method according to a preferred embodiment of the present invention.

FIG. 7 is a schematic view of the overall process of a method according to a preferred another embodiment of the present invention.

※ The accompanying drawings are included to provide a further understanding of the technical idea of the present invention, and thus the scope of the present invention is not limited thereto.

### MODE FOR CARRYING OUT THE INVENTION

In the following description of the present invention, a detailed description of known functions and configurations incorporated herein will be omitted when it may obscure the subject matter of the present invention.

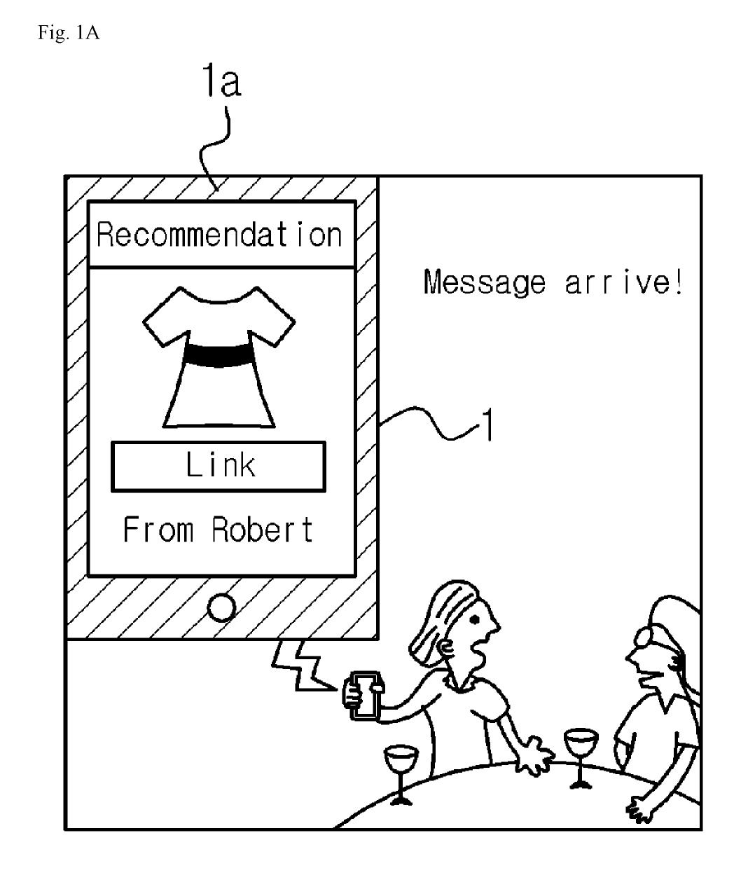

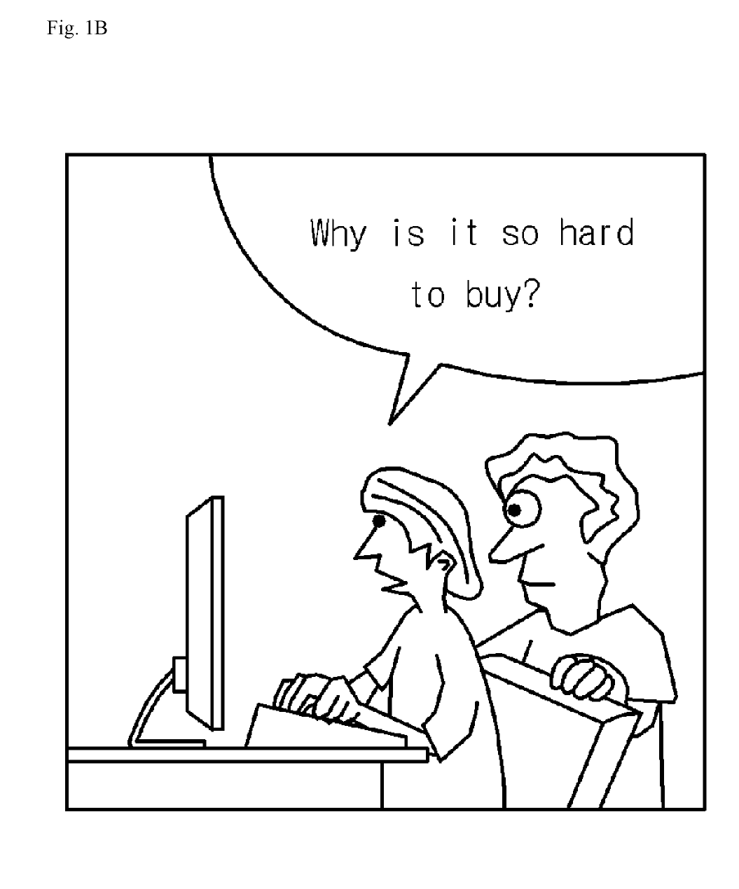

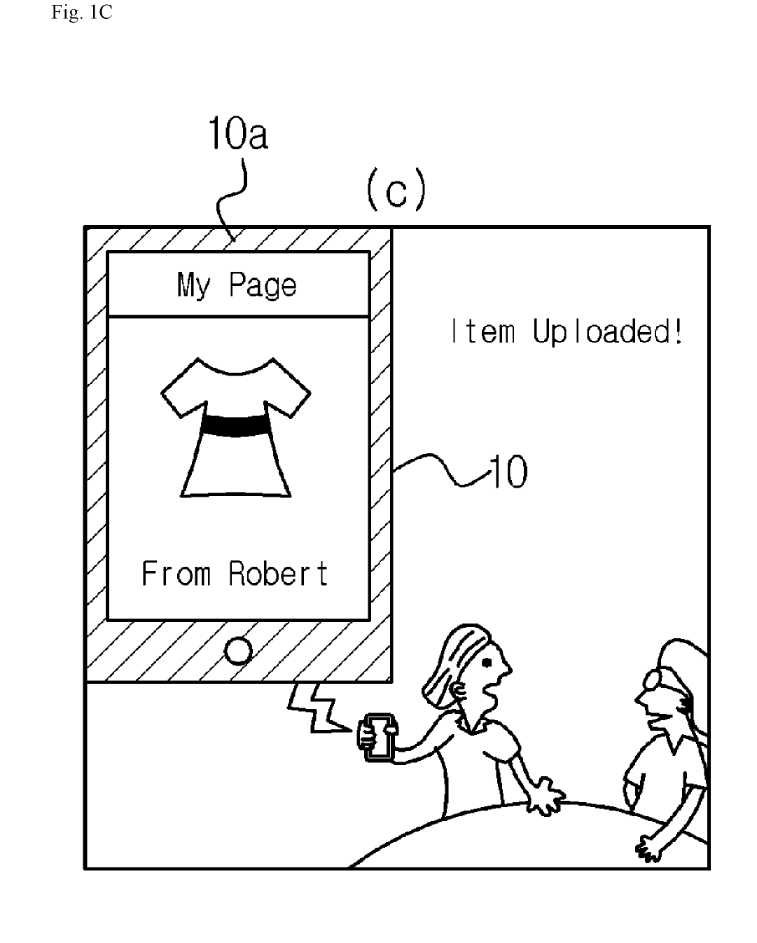

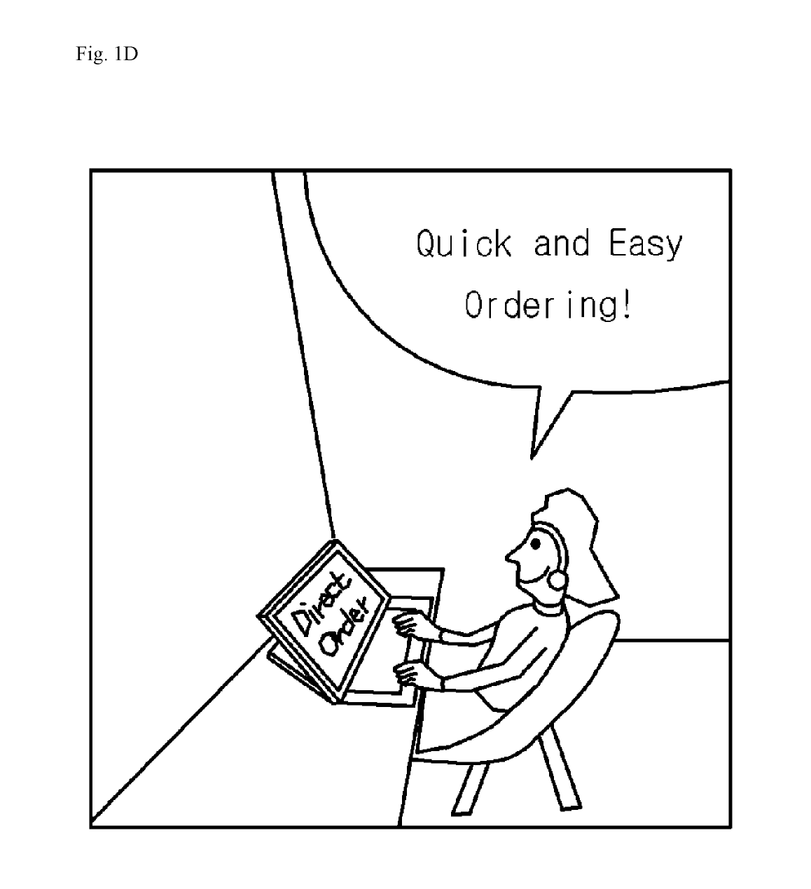

FIGS. 1A to 1D shows the basic problem awareness and solution of the present inventors in cartoon form. FIGS. 1A and 1B relate to the prior art, and FIGS. 1C and 1D relate to the present invention.

When one recommends a product through a network communication system, in general a friend sends an image of the product or sends a link to the web page where the product is located, as shown in FIG. 1A. Then, the fact that a message arrives is notified to the user device 1. In the case of an advanced service in the conventional art, a recommended product link screen 1a can be also sent together. However, when a friend recommends a certain product, it is rare to immediately click on the link and then purchase the product in real time. There are variable situations in that time, for example the user might be in conversation with someone when the link message is received. Checking the recommendation and buying the goods are usually done later, ‘If not Forgotten’. Even if a user remembers the fact that a friend recommended a product in order to make a purchase, the user must follow the procedures for signing up and logging in. If the web page would be deleted, the user should find the product page again. It is hard to remember, and even if a user remembers, it is inconvenient to buy it. FIG. 1B illustrates such a point.

On the other hand, the basic idea of the present invention is that, as shown in FIG. 1C, one inserts the product into a friend account in recommending the product. On the screen of the user device 10, the recommended product is contained in the user account page 10a itself, not in the link screen. Then, even if a user forgets the fact that a friend recommends the user a product, the user may check it later by accessing the user's account. It is possible to buy the product immediately because it is in the user's account. As described above, according to the present invention, although other recommends a product to me, the recommendation has an effective as if I put the product into my own shopping basket, and thus shopping becomes quick and easy.

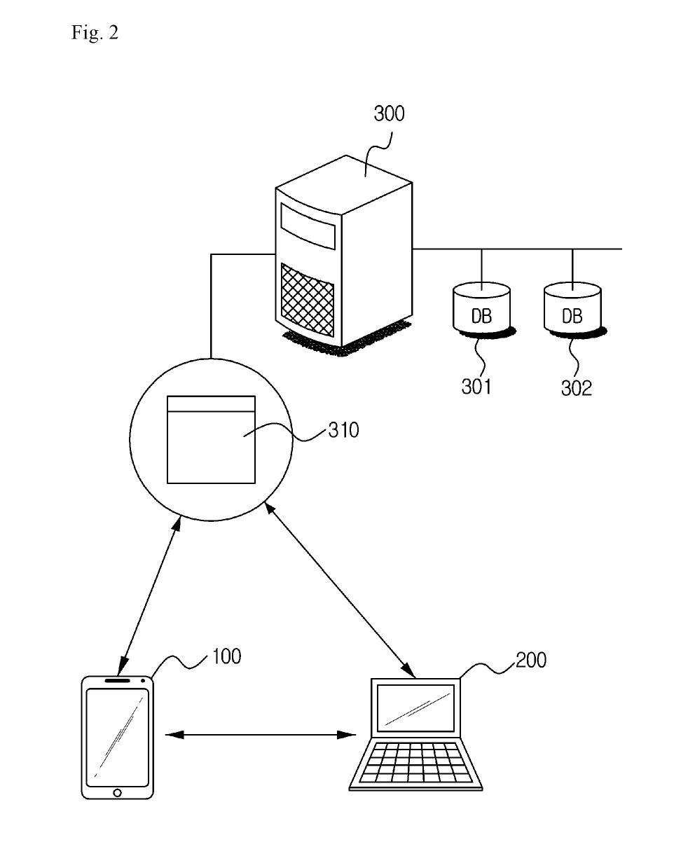

Now, the configuration and principle of the present invention will be described in earnest. FIG. 2 schematically shows a system configuration according to a preferred embodiment of the present invention.

The system of the present invention has two user devices with different concepts. The user of the first device 100 and the user of the second device 200 are friends. Here, ‘Friend Relationship’ means that the user of the first device 100 and the user of the second device 200 are subscribed to the system provided by the service server 300 and have a user account, and their user accounts are registered as friend relationship in advance. In other words, ‘Friend’ represents relationships among users on the online network, not friends in the offline real world.

Many user accounts are registered in the system, and friend relationships between these user accounts are complicatedly created. In the present invention, a device of a user account recommending an item is conceptualized as a ‘First Device’, and a device of a user account receiving an item recommendation is called as a ‘Second Device’. There will be many devices in the system in practice, but in the present invention, the devices are classified into the first device 100 and the second device 200 in terms of ‘Item Recommendation’.

In this specification, ‘Item’ is a product that may be purchased through the service server 300; and the item is used to collectively refer to a product and a service product.

The first device 100 and the second device 200 may be an electronic device such as a desktop computer or a notebook computer, or a mobile device such as a tablet PC or a smart phone. It may be enough to be able to communicate with the service server 300 and to execute the process of checking or buying the items.

Preferably, the service server 300 of the present invention operates a shopping site 310 to which the devices 100 and 200 may access. In addition, the server 300 supports and manages item information, search, order, payment service, and the like through the shopping site 310, and particularly provides the service described in the claims of the present invention.

In addition, the service server 300 performs a series of server actions including various events, data processing, database management, data transmission/reception, security, and encryption. The server 300 may include one or more hardware/software devices; and configured with a structure where the plurality of server groups may communicate with each other.

In one preferred embodiment of the present invention, the service server 300 is a server operating a web-based online shopping site. In another preferred embodiment of the present invention, the service server 300 is a server operating a mobile application that provides a shopping service. In the other preferred embodiment of the present invention, the service server 300 may be a server that operates an SNS platform, a portal platform, and other general web sites, and provides shopping services thereto. A combination of the above embodiments may be used. In such a way, the server may be modified in various ways. However, the relationship between the first device 100 and the second device 200 will be common to all, as described in detail below.

On the other hand, the server 300 constructs a plurality of databases in advance. As such a database, a database 301 stores item information. Also, a database 302 records and manages registered user information. In addition, there will be additional databases required for server operation. Although a database is not shown, but there are databases in the server system such as an advertising database, a log database, a billing database, and the like.

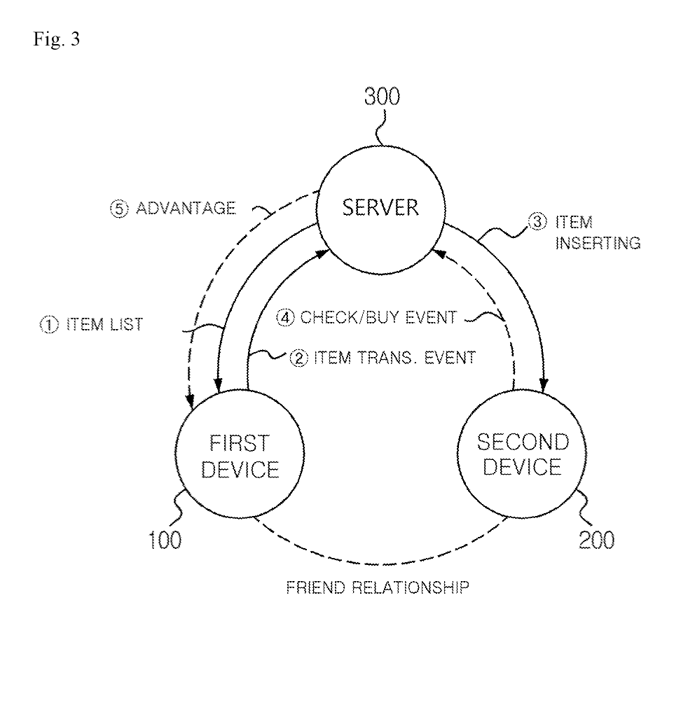

FIG. 3 conceptually shows the network action relationship between the service server 300, the first device 100 and the second device 200, according to a preferred embodiment of the present invention.

The first device 100 and the second device 200 may generate the friend relationship with each other in the server 300 in advance. In addition, the devices 100 and 200 are registered in the service server 300 as subscribers and have a unique account.

The service server 300 provides an item list to the first device 100. Generally, when the first device 100 accesses the site of the service server 300, the item list is displayed on the screen of the first device 100 through a predetermined web page or a predetermined mobile page. The first device 100 will browse the item list provided by the service server 300 through the screen and perform an event such as searching for and/or buying an item when necessary. Up to this point, there is no big difference in accessing a regular online site and doing shopping related activities.

An especially important one in the present invention is the next process. The first device 100 selects a specific item. And, a user account of the second device registered as a friend relationship is designated. Then, it executes an event for recommending the selected item to the user of the second device 200. In the present specification, this is referred to as ‘Item Transmission Event’. It is not a configuration in which the first device 100 directly transmits information on the recommended product to the second device 200 via the communication network; but it is a configuration in which the first device 100 requests the server 300 to insert a recommended product into a page of the user account of the second device 200.

When an item transmission event occurs, the server 300 inserts the selected item into an item page of the user account of the second device 200. In the present specification, the ‘Item Page’ is a part of a user account page that a device may access after logging in and connecting to a server; and refers to the page on which the friend recommended item is located. Preferably, it may be ‘Shopping Cart’ or ‘Wish List Page’. Also, more preferably, it may be configured separately from the ‘Friend Recommendation List’ to be distinguished from the existing pages.

The second device 200 may access the service server 300 and log in, and then check the item recommended by the first device 100 on the item page of the own account. It may be purchased immediately after this checking event.

By this, it is the basic relationship of the components. In addition, the service server 300 may execute an advantage event with the user account of the first device. For example, if an item is recommended to a friend, a point for the recommendation event may be provided. Preferably, when the recommended event leads to the purchase event, it may be recorded and may get the point. It may be an advantage such as issuing coupons as to the points or offering products free of charge. An embodiment of the invention will include such an advantage event, but other embodiments of the present invention may not include the advantage event.

The basic relationship of the present invention as described above is such a configuration that, when ‘I’ recommends a product to ‘a friend’, the product is automatically inserted into a user account page of the ‘friend’. By exchanging links by users, there is a distinct difference from the configuration in which a ‘friend’ acts as an online shopper separately, as described with reference to FIGS. 1A to 1D. Also, the basic feature of the present invention is that it is not a gift method in which ‘I’ purchases the product directly (after completing payment) and then delivers the product to a friend. Such gift methods are rare in online shopping; not good means to promote shopping specifically; or not closely related to the users' daily lives. In the present invention, ‘I’ recommends something ‘friend’ made an order and payment. The ‘server’ is responsible for creating a technical environment so that friends may order easily.

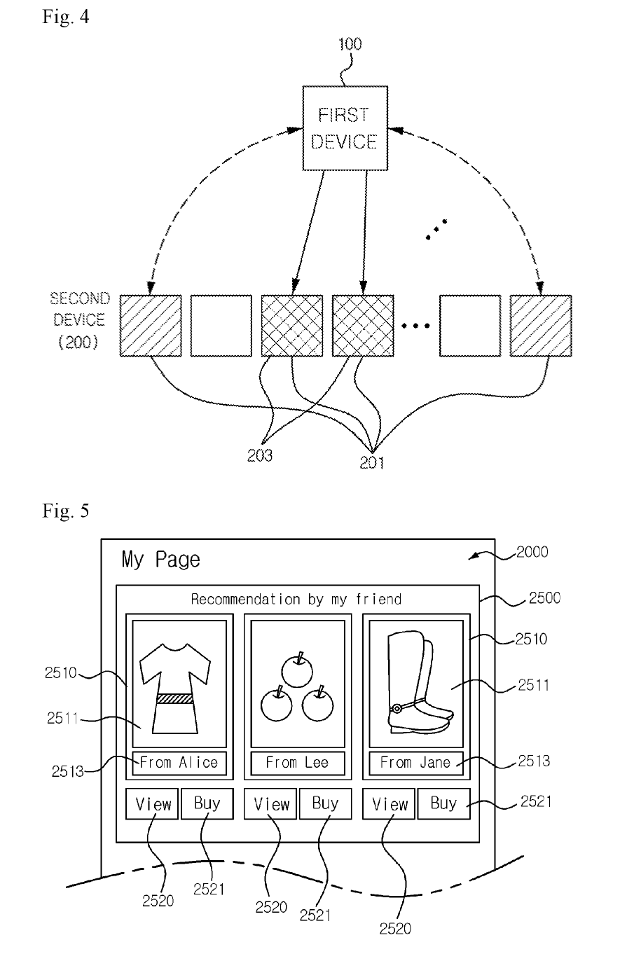

Regarding the recommendation, it may be recommended to all friends, or to some friends, or a friend. FIG. 4 schematically shows such a scenario.

The user of the first device 100 has other users as the registered friend relationships. In this case, there are a plurality of the second devices 200 from the viewpoint of the first device 100. For an item, the first device 100 may designate all the second devices 200 to execute the item transmission event described with reference to FIG. 3. Also, the first device 100 may recommend the item only by designating only one or two the second devices 201. Also, not all users who receive the item recommendation buy the item. Only some devices 203 may buy the item as shown in the drawing. As a result, there is a second device 203 in which the product recommendation event generated from the first device 100 continues to the purchase event in the network system managed by the service server system, and the item has been spread over the social network.

FIG. 5 shows a user screen in which the item recommended by the first device user is automatically inserted by the server when the second device connects to the server and logs in to the user account in a preferred embodiment of the present invention.

The user account page 2000 of FIG. 5 includes an item page 2500. The item page 2500 displays an item list 2510 recommended by another user (a user of the first device 100) registered as a friend relationship. As shown in the drawing, the item list 2510 recommended by different users may be displayed together.

The item list 2510 includes a product information area 2511 and a recommender information area 2513. These areas 2511 and 2513 are conceptually distinguished and not necessarily physically separated. Information of a recommended friend's name, account, product name, image, price, and the like may be displayed.

The item page 2500 may include a view button 2520 and a purchase button 2521 for each item list 2510. Pressing the view button 2520 goes to the product detail page. Pressing the purchase button 2521 goes directly to the payment page.

The user interface configuration of FIG. 5 may be designed in various ways. If it is a configuration in which the user's item page 2500 contains a recommendation item inserted by the server at the request of a friend account, the technical scope of the present invention may not be limited by various screen design changes.

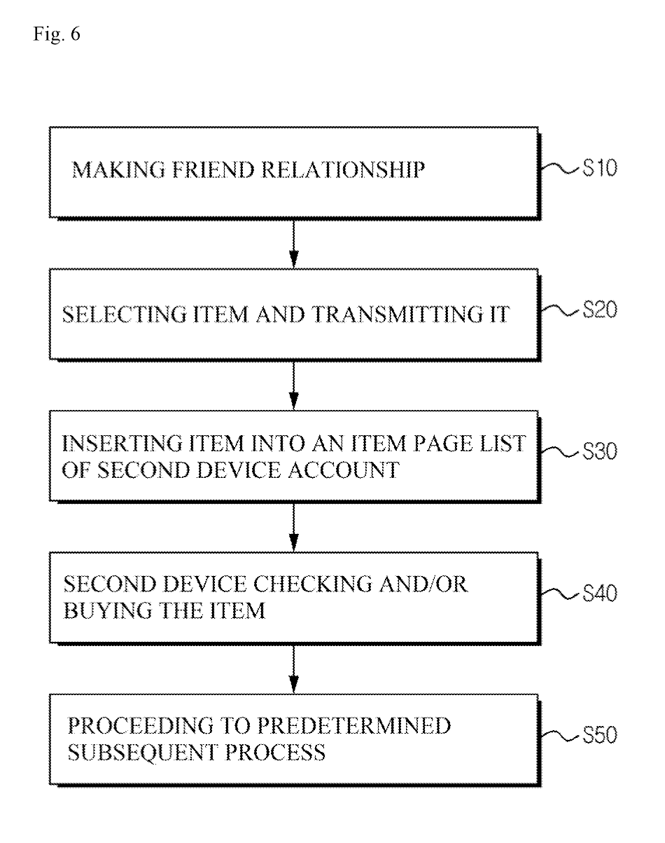

Based on the above detailed description, now, the overall process that constitutes the method of the present invention is summarized as a preferred embodiment(s) and is shown in FIG. 6. The method of the present invention is a method of pushing the item to the friend account in an online or mobile system. Furthermore, the method of the present invention is an online shopping method. In addition, the method of the present invention may be a mobile shopping method.

First, the first device registers a friend relationship with N second devices (S10). In some embodiments, N is an integer greater than or equal to one. It includes a case where there is one friend user. In yet another embodiment, N is an integer greater than one. A friend user is basically in plurality.

Operation S10 is based on a procedure in which a user of devices subscribes to a service of the server. This is generally performed by accessing various types of systems, such as shopping sites, online sites, portal sites, and mobile platforms, provided by the server, through the subscription procedure. Usually, other user accounts are then registered as friend relationship, concurrently, sequentially, and as needed.

Next, the first device connects to the server, selects an item provided by the server system, and designates K (K is an integer equal to or less than N) second device user accounts to generate the item transmission event (S20). Through the item transmission event, the item and other users who recommend the item are specified.

Then, the server inserts the item into the item page list of the specified user account (S30).

Next, P (P is an integer equal to or less than K) second device users connect to the server and log in (login status may be maintained at the time of connection); and check and/or buy the item inserted in his/her item page (S40). For how operation S40 is performed, we may confirm it through the screen scenario of FIG. 5.

Next, the server proceeds to a predetermined subsequent process (S50). Various events may be included in operation S50 such as a log event (a log from the item recommendation to the item purchase is recorded), and an advantage event (a predetermined device advantage is given to the first device user who has recommended the product, and this is the same as described above). A notification event (notifying via the communication network that operation S40 has been performed by the friend device recommending the product), and the like may be included.

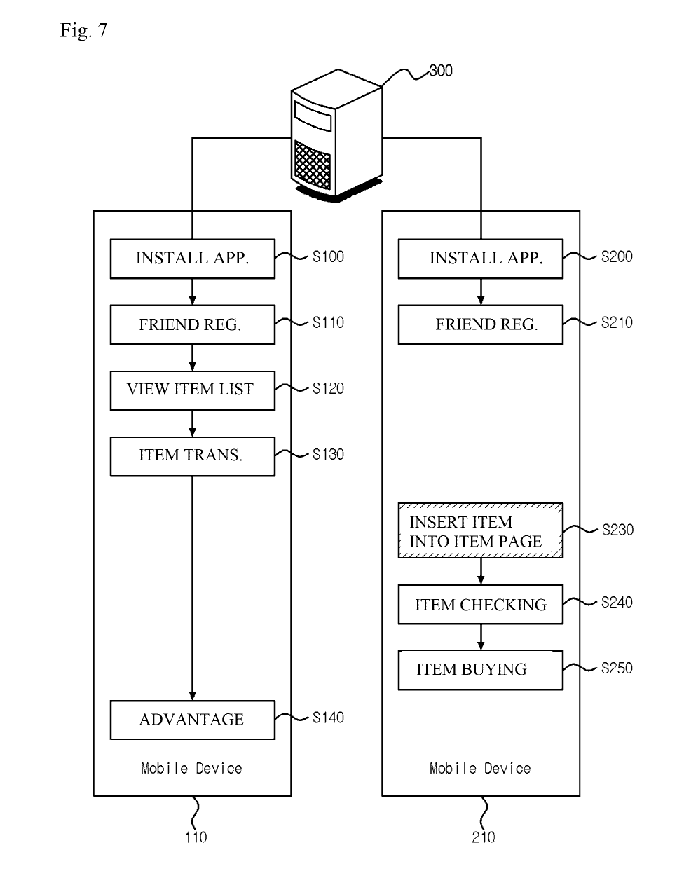

The process of FIG. 6 is preferably performed, for example, at a shopping mall Internet site. The readers of the present specification may imagine implementing the features of the present invention in a typical online shopping site. But it is not necessarily limited to that. For example, FIG. 7 shows that the features of the present invention may be implemented on a mobile application basis.

A mobile application is installed on each of the first mobile device 110 and the second mobile device 210 (S100, S200). The mobile application provides product information, search means, order and payment modules, and the like. The mobile application itself is widely used commercially and is obvious to a person skilled in the art. The present invention preferably includes a module for registering a friend relationship, a module for recommending an item to a friend, a module for displaying a recommended item, and a module for ordering a recommended item.

Next, the user of the first mobile device 110 creates a friend relationship with another user (S110). Friend relationships between user accounts are registered on the server as if they were social networks like Facebook or LinkedIn. Operation S110 is not necessarily performed in the mobile device. Once a user has logged in to the server from another device and has already registered friendship, the friendship will be also automatically registered on a mobile application. This is because the information on the friendship is stored in the server. The operation in the second mobile device corresponding to operation S110 is operation S210.

Next, the item list is displayed on the mobile application screen of the first mobile device (S120).

The input means of the first mobile device 110 selects an item and designates the user account of the second mobile device 210 that is registered as a friend. Then, an event for recommending a corresponding item, that is, an event for requesting the server to transmit the item to the second mobile device 210 with a designated user account, is generated (S130). Such an event is generated by pressing the button displayed on the user screen by the input means.

Then, the server inserts the recommended item into the item page of the user account specified in the first mobile device 110 (S230). Preferably, the server preferably notifies the second mobile device 110 that the friend has recommended the item. For example, the application may output a notification with a text message and/or an alarm tone.

Then, when the second mobile device 210 executes the mobile application and views its own item page, the item inserted by the server in operation S230 may be checked (S240). There may be a time difference between operations S230 and S240. This is because not all users who are notified that a friend recommended an item immediately check it.

The user of the second mobile device executed up to operation S240 may make a purchase if necessary (S250). However, a purchase event does not necessarily occur.

In some preferred embodiments, the advantage event described above may be performed by the first mobile device that recommends the item to a friend via the application (S140).

For reference, an online shopping method, a method of pushing an item to a friend account, or a mobile shopping method according to an embodiment of the present invention may be implemented in the form of a program command that may be executed through various computer means and may be recorded in a computer readable medium. The computer-readable medium may include program instructions, data files, data structures, and the like, alone or in combination. It may be understood that program instructions stored in the medium are specially designed and configured for the present disclosure or are well known to those skilled in computer software and used. Examples of computer readable media may include magnetic media such as hard disks, floppy disks, and magnetic tape, optical recording media such as CD-ROMs and DVDs, magneto-optical media such as floptical disks, and a hardware device specifically configured to store and execute program instructions such as ROM, RAM, flash memory, and the like. Examples of program instructions include high-level language code that may be executed by a computer using an interpreter, as well as machine code accords such as those produced by a compiler. The hardware device may be configured to operate as at least one software module to perform operations of the present invention and vice versa.

The protected scope of the present invention is not limited to the description and the expression of the embodiments explicitly described above. It is again added that the protected scope of the present invention is not limited by obvious changes or substitutions in the technical field to which the present invention belongs.

1. A method of pushing an item to a friend account, the method comprising:
a first device selecting an item from a shopping site subscribed as a first user account;
designating a second user account registered in advance as a friend relationship, and generating an item transmission event;
the shopping site server inserting the item into a list of an item page of the second user account; and
a second device of the second user account logging in to the shopping site and checking the item registered on the item page.

2. The method of claim 1, wherein the shopping site server provides the first device with second user account information of the second device through a first user account screen of the first device, and further provides the second device with the first device user account information recommending an item through the item page of the second user account of the second device.

3. An online shopping method comprising:
a first device and a second device subscribing to a shopping site;
the first device and the second device registering a friend relationship on the shopping site;
the first device selecting an item at the shopping site to generate an item transmission event to the second device;
the shopping site server inserting the item into a list of an item page of a second device account; and
the second device logging in to the shopping site confirm the item selected by the first device registered in the item page of its account and buying the item.

4. The method of claim 3, further comprising, when the item transmission event is generated, the shopping site server notifying that an item is transmitted from the first device to the second device.

5. The method of claim 3, further comprising, when the second device purchases the item, the shopping site server notifying that the second device purchases the item to the first device.

6. The method of claim 3, wherein the second device is in plurality, further comprising the shopping site server assigning a pre-determined advantage event in correspondence to each time the second device purchases the item.

7. A method of pushing an item to a friend account, the method comprising:
a first device subscribed to an online site registering a friend relationship with N (N is an integer greater than 1) second devices subscribed to the online site;
the first device selecting an item from the online site, and designating K (K is an integer larger than 1 and N or less) second devices to generate an item transmission event;
the online site server inserting the item into a list of an item page of the K second device accounts; and
logging, by the second device that is a target of the item transmission event of the first device, in to the online site checking the item included in the list of the item page.

8. The method of claim 7, further comprising the second device executing a purchase event for the item included in the item page,
wherein depending a purchase event, the online site server provides the second device with a pre-determined purchasing process and executes an advantage event on the first device when the purchasing process is completed.

9. A mobile shopping method comprising:
a first mobile device and a second mobile device installing a mobile shopping application provided by a shopping service server;
the first mobile device and the second mobile device creating a friend relationship to register it on the shopping service;
after the first mobile device executes the mobile shopping application, selecting an item, designating the second mobile device, and generating an item transmission event;
the shopping service server inserting the item into a list of an item page of the account of the second mobile device; and
the second mobile device executing the mobile shopping application to check the item included in a list of the item page and executing a purchase event for this item.

10. The method of claim 9, wherein the second mobile device is in plurality.
